(19) United States
(12) Patent Application Publication
(10) Pub. No.: US 2025/0192322 A1
(43) Pub. Date: Jun. 12, 2025

(54) TRACTION BATTERY PACK CONNECTIONS FOR CONTAINING BATTERY CELL EXPANSION FORCES

(71) Applicant: FORD GLOBAL TECHNOLOGIES, LLC, Dearborn, MI (US)

(72) Inventor: Douglas Christian Lipp, Ann Arbor, MI (US)

(21) Appl. No.: 18/814,874

(22) Filed: Aug. 26, 2024

Related U.S. Application Data
(60) Provisional application No. 63/607,888, filed on Dec. 8, 2023.

(51) Int. Cl. H01M 50/264; B60L 50/64; H01M 50/211; H01M 50/242; H01M 50/249

(52) U.S. Cl. CPC H01M 50/264; B60L 50/64; H01M 50/211; H01M 50/242; H01M 50/249; H01M 2220/20

(57) ABSTRACT

Battery structural connections are provided for containing battery cell expansion forces within a traction battery pack. An exemplary traction battery pack may provide structural connections between each of a plurality of cell stacks and a structural plate member that is arranged to span the plurality of cell stacks. Each cell stack may include a pair of cross-member assemblies, and each cross-member assembly may include a threaded rod that is receivable through an opening of the structural plate member. A nut may be secured to the threaded rod for containing battery cell expansion forces.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to battery structural connections for containing battery cell expansion forces within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a plurality of battery cells arranged between a first cross-member assembly and a second cross-member assembly. The first cross-member assembly and the second cross-member assembly each include a ladder frame and a threaded rod mounted within a groove of the ladder frame.

In a further non-limiting embodiment of the foregoing traction battery pack, a first reinforcement beam is mounted to the ladder frame and is arranged to cover an unthreaded portion of the threaded rod.

In a further non-limiting embodiment of either of the foregoing traction battery packs, the first reinforcement beam is a pultruded beam structure.

In a further non-limiting embodiment of any of the foregoing traction battery packs, the ladder frame includes a first engagement feature that is configured to interdigitate with a second engagement feature of the first reinforcement beam.

In a further non-limiting embodiment of any of the foregoing traction battery packs, the first engagement feature includes a first finger that is received within a first slot of the second engagement feature. The second engagement feature includes a second finger received within a second slot of the first engagement feature.

In a further non-limiting embodiment of any of the foregoing traction battery packs, the groove extends from the second slot into a material thickness of the ladder frame.

In a further non-limiting embodiment of any of the foregoing traction battery packs, the threaded rod includes a threaded end portion that protrudes outside of the ladder frame.

In a further non-limiting embodiment of any of the foregoing traction battery packs, the threaded end portion is received through an opening of a structural plate member that is arranged between the cell stack and a side wall of an enclosure assembly.

In a further non-limiting embodiment of any of the foregoing traction battery packs, a nut is received over the threaded end portion for securing the structural plate member to the cell stack.

In a further non-limiting embodiment of any of the foregoing traction battery packs, a first reinforcement beam and a second reinforcement beam are mounted to the ladder frame. The first reinforcement beam establishes a first pultrusion of the first cross-member assembly or the second cross-member assembly, and the second reinforcement beam establishes a second pultrusion of the first cross-member assembly or the second cross-member assembly.

A traction battery pack according to another exemplary aspect of the present disclosure includes, among other things, an enclosure assembly providing an interior area, a plurality of cell stacks arranged within the interior area, and a structural plate member positioned to span the plurality of cell stacks at a location between the plurality of cell stacks and a side wall of the enclosure assembly. The plurality of cell stacks each include a cross-member assembly that includes a threaded rod received through an opening of the structural plate member. A nut is received on the threaded rod for securing the structural plate member to at least one cell stack of the plurality of cell stacks.

In a further non-limiting embodiment of the foregoing traction battery pack, the structural plate member spans across an entire length of the side wall.

In a further non-limiting embodiment of either of the foregoing traction battery packs, the threaded rod is mounted within a groove of a ladder frame of the cross-member assembly.

In a further non-limiting embodiment of any of the foregoing traction battery packs, a first reinforcement beam of the cross-member assembly is mounted to the ladder frame and is arranged to cover an unthreaded portion of the threaded rod.

In a further non-limiting embodiment of any of the foregoing traction battery packs, the first reinforcement beam is a pultruded beam structure.

In a further non-limiting embodiment of any of the foregoing traction battery packs, the threaded rod includes a threaded end portion that protrudes outside of the ladder frame and is received through the opening of the structural plate member.

In a further non-limiting embodiment of any of the foregoing traction battery packs, the nut is secured to the threaded end portion.

In a further non-limiting embodiment of any of the foregoing traction battery packs, a second threaded rod is mounted within a second groove of the ladder frame.

In a further non-limiting embodiment of any of the foregoing traction battery packs, a second reinforcement beam of the cross-member assembly is mounted to the ladder frame and is arranged to cover an unthreaded portion of the second threaded rod.

In a further non-limiting embodiment of any of the foregoing traction battery packs, the cross-member assembly includes a second threaded rod received through a second opening of the structural plate member. A second nut is received on the second threaded rod for securing the structural plate member to the at least one cell stack of the plurality of cell stacks.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates a cross-member assembly of the traction battery pack of FIG. 2.

FIG. 4 is an exploded view of the cross-member assembly of FIG. 3.

FIG. 5 illustrates an exemplary interface between battery cell stack cross-member assemblies and a structural plate member of a traction battery pack.

### DETAILED DESCRIPTION

This disclosure relates to battery structural connections for containing battery cell expansion forces within a traction battery pack. An exemplary traction battery pack provides structural connections between each of a plurality of cell stacks and a structural plate member that is arranged to span the plurality of cell stacks. Each cell stack may include a pair of cross-member assemblies, and each cross-member assembly may include a threaded rod that is receivable through an opening of the structural plate member. A nut may be secured to the threaded rod for containing battery cell expansion forces. These and other features are discussed in greater detail in the following paragraphs of this detailed description.

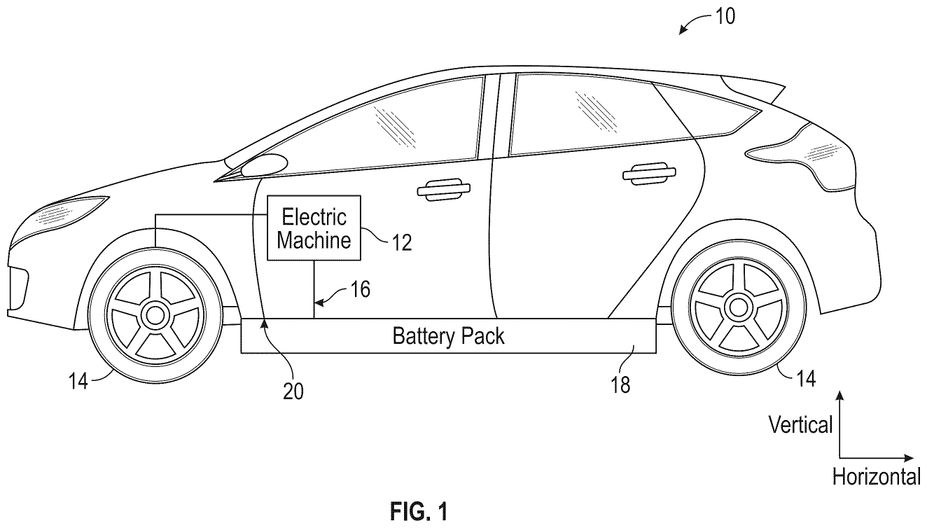

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

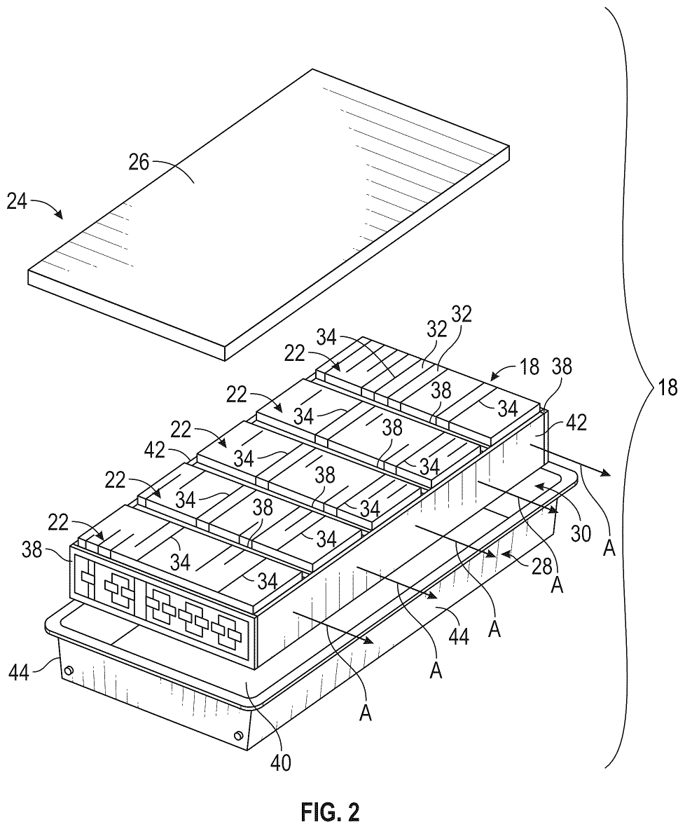

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, for providing the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments of battery cells 32. Each compartment may hold one or more of the battery cells 32 of the cell stack 22.

The battery cells 32 and the thermal barrier assemblies 34 of each cell stack 22 may be arranged to extend laterally between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed in a direction along each cell stack axis A. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed on the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g. perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

In an embodiment, the cell stacks 22 and the cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

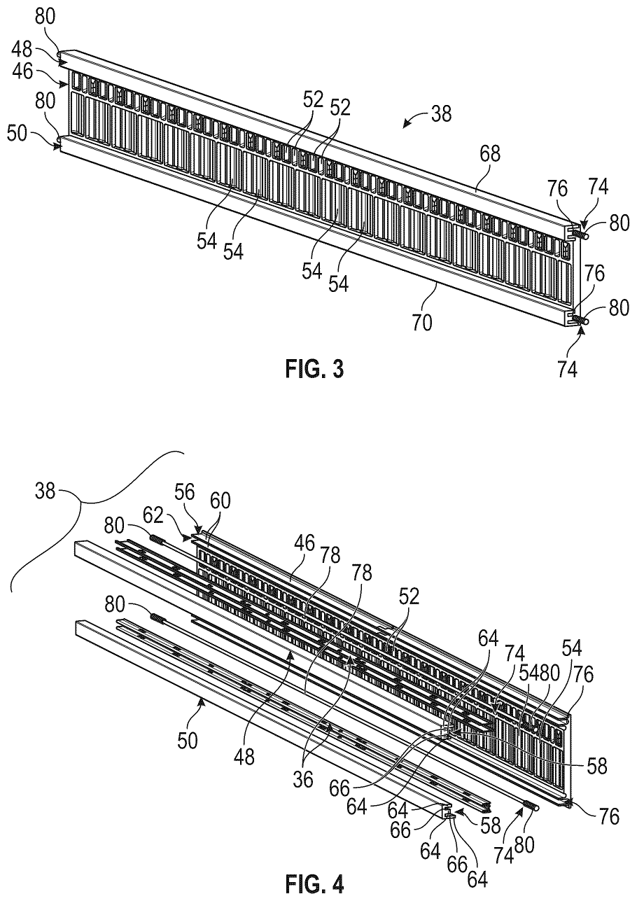

FIGS. 3 and 4 (with continued reference to FIG. 2) further illustrate details associated with one of the cross-member assemblies 38 of the traction battery pack 18. The additional cross-member assemblies of the traction battery pack 18 could include a design that is substantially similar to the cross-member assembly 38 shown in FIGS. 3-4.

The cross-member assembly 38 may include a ladder frame 46 and one or more reinforcement sections. In the illustrated embodiment, the cross-member assembly 38 includes an upper or first reinforcement beam 48 and a lower or second reinforcement beam 50. However, other configurations are also contemplated within the scope of this disclosure.

The ladder frame 46 may be either a unitary or multi-piece injection molded structure. The ladder frame 46 may be made of any suitable thermoplastic material.

The ladder frame 46 may include one or more vent openings 52 for communicating battery cell vent byproducts through the ladder frame 46 and into a passageway located between adjacent cell stacks 22. The vent openings 52 may thus provide a pathway for battery cell vent byproducts to move through the cross-member assembly 38 as may be required during a cell venting event, for example.

The ladder frame 46 may additionally include a plurality of cell tab openings 54 arranged vertically below the vent openings 52. The cell tab openings 54 may be elongated slots configured to accommodate the cell tab terminals of the battery cells 32. In an embodiment, each cell tab opening 54 may accommodate one cell tab terminal. In another embodiment, each cell tab opening 54 may be sized to receive cell tab terminals from multiple adjacent battery cells 32.

In an assembled state of the cross-member assembly 38, both the vent openings 52 and the cell tab openings 54 are located between the first and second reinforcement beams 48, 50 (see, e.g., FIG. 3). However, other configurations are possible within the scope of this disclosure.

The first reinforcement beam 48 and the second reinforcement beam 50 may be mounted at separate locations of the ladder frame 46 for structurally reinforcing the cross-member assembly 38. The ladder frame 46 and the first and second reinforcement beams 48, 50 may include mateable features that facilitate the connection of the first and second reinforcement beams 48, 50 to the ladder frame 46. For example, the ladder frame 46 may include first engagement features 56 that are configured to mesh or interdigitate with a second engagement feature 58 of the first reinforcement beam 48 or the second reinforcement beam 50. In an embodiment, the first engagement features 56 each include a first arrangement of fingers 60 and slots 62, and the second engagement features 58 each include a second arrangement of fingers 64 and slots 66. The fingers 60 of the first engagement features 56 can be received in the slots 66 of the second engagement features 58 and vice versa in order to mount the first and second reinforcement beams 48, 50 to the ladder frame 46. An adhesive 36 may be applied between the first and second engagement features 56, 58 for further facilitating the connection of the first and second reinforcement beams 48, 50 to the ladder frame 46.

In an embodiment, the second engagement feature 58 of each of the first reinforcement beam 48 and the second reinforcement beam 50 includes an E-shaped cross-section (see FIG. 4). However, other cross-sectional shapes are contemplated within the scope of this disclosure.

In an embodiment, the first and second reinforcement beams 48, 50 are pultrusions, which implicates structure to these beam-like structures. A person of ordinary skill in the art having the benefit of this disclosure would understand how to structurally distinguish a pultruded beam structure from another type of structure, such as an extruded beam, for example.

The first and second first reinforcement beams 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second first reinforcement beams 48, 50.

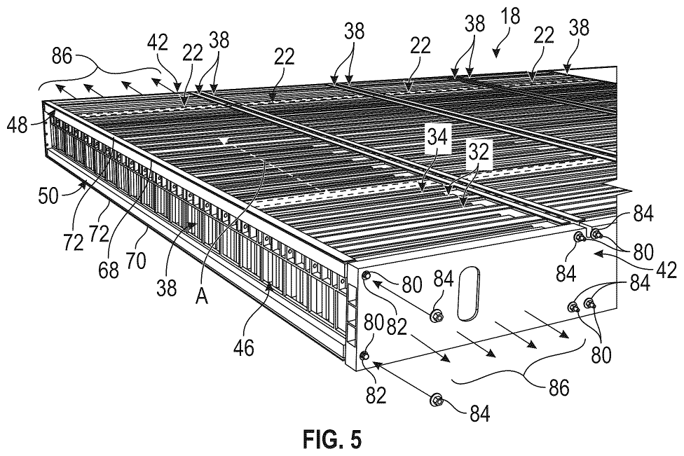

When mounted to the ladder frame 46, the first reinforcement beam 48 may establish an upper plateau 68 of the cross-member assembly 38, and the second reinforcement beam 50 may establish a lower base 70 of the cross-member assembly 38. An adhesive 72 (see FIG. 5) may be applied to the upper plateau 68 and to the lower base 70 for securing the cross-member assembly 38 directly to the enclosure cover 26 and to either the heat exchanger plate 40 or the enclosure tray 28, respectively. The cell stacks 22 may therefore be structurally integrated with the enclosure assembly 24 of the traction battery pack 18.

The cross-member assembly 38 may additionally include one or threaded rods 74. As further discussed below, the threaded rods 74 can facilitate connection of the structural plate members 42 to the cell stacks 22 within the traction battery pack 18, thereby further structurally integrating the traction battery pack 18.

In an embodiment, the cross-member assembly 38 includes two threaded rods 74, with one threaded rod 74 being secured to the ladder frame 46 at a location adjacent to the first reinforcement member 48, and the other threaded rod 74 being secured to the ladder frame 46 at a location adjacent to the second reinforcement member 50. However, the cross-member assembly 38 could include a greater or fewer number of threaded rods 74 within the scope of this disclosure.

Each first engagement feature 56 of the ladder frame 46 may include a groove 76 sized to receive one of the threaded rods 74. The groove 76 may be a portion of the slot 62 that extends further into the material thickness of the ladder frame 46. The first and second reinforcement beams 48, 50 may be secured to the ladder frame 46 (i.e., via the interconnection of the first and second engagement features 56, 58) to retain the threaded rods 74 within the grooves 76. Notably, the fingers 64 that are received within the slots 62 are not long enough to extend into the grooves 76 but are long enough to substantially cover the threaded rods 74. The second engagement features 58 thus provide rod encapsulating features for retaining the threaded rods 74 within the grooves 76.

Each threaded rod 74 may be a metallic component that includes an unthreaded portion 78 that extends between a pair of threaded end portions 80. The unthreaded portion 78 and the threaded end portions 80 are integrated to provide a unitary structure of the threaded rod 74. In an assembled condition of the cross-member assembly 38, the unthreaded portion 78 is accommodated within a respective one of the grooves 76, and the threaded end portions 80 project outside of the groove 76 and are thus exposed outside of the ladder frame 46 at each opposing longitudinal end of the cross-member assembly 38.

Referring now primarily to FIG. 5, with continued reference to FIGS. 3-4, the threaded end portions 80 of each thread rod 74 of each cross-member assembly 38 may provide a stud-like structures for establishing a structural connection between the cell stacks 22 and the structural plate members 42 of the traction battery pack 18. For example, each threaded end portion 80 may be received through an opening 82 formed through one of the structural plate members 42. A nut 84 may then be secured to the threaded end portions 80 and then tightened down for securing the structural plate member 42 to the cell stacks 22 and thus further structurally integrating the traction battery pack 18. This cross-member assembly-to-structural plate member connection can help contain tensile loads that can occur over the life of the cell stacks 22 as a result of battery cell expansion forces 86 (shown schematically) that are exerted along the cell stack axes A.

The exemplary traction battery packs of this disclosure include cross-member assembly-to-structural plate member connections that structurally integrate the traction battery pack. Advantageously, these connections may be configured for containing battery cell expansion forces within traction battery packs without the risk of jack-out of threaded inserts.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a plurality of battery cells arranged between a first cross-member assembly and a second cross-member assembly; and
the first cross-member assembly and the second cross-member assembly each including a ladder frame and a threaded rod mounted within a groove of the ladder frame.

2. The traction battery pack as recited in claim 1, comprising a first reinforcement beam mounted to the ladder frame and arranged to cover an unthreaded portion of the threaded rod.

3. The traction battery pack as recited in claim 2, wherein the first reinforcement beam is a pultruded beam structure.

4. The traction battery pack as recited in claim 2, wherein the ladder frame includes a first engagement feature that is configured to interdigitate with a second engagement feature of the first reinforcement beam.

5. The traction battery pack as recited in claim 4, wherein the first engagement feature includes a first finger that is received within a first slot of the second engagement feature, and further wherein the second engagement feature includes a second finger received within a second slot of the first engagement feature.

6. The traction battery pack as recited in claim 5, wherein the groove extends from the second slot into a material thickness of the ladder frame.

7. The traction battery pack as recited in claim 1, wherein the threaded rod includes a threaded end portion that protrudes outside of the ladder frame.

8. The traction battery pack as recited in claim 7, wherein the threaded end portion is received through an opening of a structural plate member that is arranged between the cell stack and a side wall of an enclosure assembly.

9. The traction battery pack as recited in claim 8, comprising a nut received over the threaded end portion for securing the structural plate member to the cell stack.

10. The traction battery pack as recited in claim 1, comprising a first reinforcement beam and a second reinforcement beam mounted to the ladder frame, wherein the first reinforcement beam establishes a first pultrusion of the first cross-member assembly or the second cross-member assembly, and the second reinforcement beam establishes a second pultrusion of the first cross-member assembly or the second cross-member assembly.

11. A traction battery pack, comprising:
an enclosure assembly providing an interior area;
a plurality of cell stacks arranged within the interior area;
a structural plate member positioned to span the plurality of cell stacks at a location between the plurality of cell stacks and a side wall of the enclosure assembly;
the plurality of cell stacks each including a cross-member assembly that includes a threaded rod received through an opening of the structural plate member; and
a nut received on the threaded rod for securing the structural plate member to at least one cell stack of the plurality of cell stacks.

12. The traction battery pack as recited in claim 11, wherein the structural plate member spans across an entire length of the side wall.

13. The traction battery pack as recited in claim 11, wherein the threaded rod is mounted within a groove of a ladder frame of the cross-member assembly.

14. The traction battery pack as recited in claim 13, wherein a first reinforcement beam of the cross-member assembly is mounted to the ladder frame and is arranged to cover an unthreaded portion of the threaded rod.

15. The traction battery pack as recited in claim 14, wherein the first reinforcement beam is a pultruded beam structure.

16. The traction battery pack as recited in claim 13, wherein the threaded rod includes a threaded end portion that protrudes outside of the ladder frame and is received through the opening of the structural plate member.

17. The traction battery pack as recited in claim 16, wherein the nut is secured to the threaded end portion.

18. The traction battery pack as recited in claim 13, comprising a second threaded rod mounted within a second groove of the ladder frame.

19. The traction battery pack as recited in claim 18, wherein a second reinforcement beam of the cross-member assembly is mounted to the ladder frame and is arranged to cover an unthreaded portion of the second threaded rod.

20. The traction battery pack as recited in claim 11, wherein the cross-member assembly includes a second threaded rod received through a second opening of the structural plate member, and comprising a second nut received on the second threaded rod for securing the structural plate member to the at least one cell stack of the plurality of cell stacks.
